(19) United States
(12) Patent Application Publication
(10) Pub. No.: US 2006/0169512 A1
(43) Pub. Date: Aug. 3, 2006

(54) Vehicle

(76) Inventors: Eiji Tomii, Shizuoka (JP); Yoshinori Ookuwa, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(21) Appl. No.: 11/318,810

(22) Filed: Dec. 27, 2005

(30) Foreign Application Priority Data
Dec. 28, 2004 (JP) 2004-381182

(51) Int. Cl. B62K 11/00

(52) U.S. Cl. 180/219

(57) ABSTRACT

A motorcycle comprises a hydraulic valve driving device operable to drive an intake valve and an exhaust valve, and a hydraulic path used for driving the hydraulic valve driving device. The hydraulic path is arranged inside an outermost line connecting respective outermost portions of constituent elements, other than the hydraulic path, of a vehicle body.

### BACKGROUND OF THE INVENTION

1. Field of the Invention

The present invention relates to a vehicle, and more particularly, to a vehicle including a hydraulic valve driving device for driving an engine valve.

2. Description of the Background Art

Motorcycles (vehicles) including hydraulic valve driving devices for driving engine valves have been conventionally known (see JP 9-112229 A, for example). In a valve driving device for an internal combustion engine (engine) in the motorcycle disclosed in JP 9-112229 A, hydraulic pressure is introduced into hydraulic cylinders respectively mounted on an intake valve and an exhaust valve (engine valves) through an intake-side hydraulic path and an exhaust-side hydraulic path (hydraulic paths) so that the intake valve and the exhaust valve are driven.

In a configuration disclosed in JP 9-112229 A, however, the intake-side hydraulic path and the exhaust-side hydraulic path are exposed to the exterior, so that the intake-side hydraulic path and the exhaust-side hydraulic path are brought into contact with the ground when the motorcycle falls. Consequently, the intake-side hydraulic path and the exhaust-side hydraulic path may, in some cases, be damaged. When the intake-side hydraulic path and the exhaust-side hydraulic path are thus damaged, travel may, in some cases, be impossible.

### SUMMARY OF THE INVENTION

In order to overcome the problems described above, preferred embodiments of the present invention provide a vehicle capable of preventing a hydraulic path from being damaged even when the vehicle falls.

(1)

According to a preferred embodiment of the present invention, a vehicle comprises an engine having a valve; a hydraulic valve driving device operable to drive the valve; and a hydraulic path arranged to supply a driving force to the hydraulic valve driving device, the engine, the hydraulic valve driving device, and the hydraulic path constituting part of a vehicle body, and the hydraulic path being arranged inside an outermost line connecting respective outermost portions of constituent elements, other than the hydraulic path, of the vehicle body.

In the vehicle, the hydraulic path for supplying a driving force to the hydraulic valve driving device is arranged inside the outermost line connecting the respective outermost portions of the constituent elements, other than the hydraulic path, of the vehicle body. When the vehicle falls, therefore, the outermost portions of the constituent elements, other than the hydraulic path, of the vehicle body can be abutted against the ground. Consequently, the hydraulic path can be prevented from being abutted against the ground. As a result, even in a case where the vehicle falls, the hydraulic path can be prevented from being damaged.

(2)

The vehicle body may further comprise a vehicle body frame that holds the engine, and a fuel tank mounted on the vehicle body frame, and the hydraulic path may be arranged inside an outermost line connecting at least two of an outer portion of the engine, an outer portion of the fuel tank, and an outer portion of the vehicle body frame.

In this case, the hydraulic path can be arranged inside the outermost line connecting the outer portion of the engine that is high in mechanical strength and the outer portion of the fuel tank, the outermost line connecting the outer portion of the fuel tank and the outer portion of the vehicle frame, or the outermost line connecting the outer portion of the engine and the outer portion of the vehicle frame. In a case where the vehicle falls, therefore, the hydraulic path can be easily prevented from being abutted against the ground. Consequently, the hydraulic path can be easily prevented from being damaged.

(3)

The hydraulic path may comprise a first hydraulic path connected to the hydraulic valve driving device, the engine may further comprise a hydraulic pump operable to drive the hydraulic valve driving device and a pump cover that protects the hydraulic pump, the first hydraulic path may comprise a high-pressure pipe that connects the hydraulic pump and the hydraulic valve driving device, and the high-pressure pipe may be arranged inside an outermost line connecting the outer portion of the fuel tank and an outer portion of the pump cover.

In this case, in a case where the vehicle falls, the outer portion of the fuel tank and the outer portion of the pump cover can be abutted against the ground. Consequently, the high-pressure pipe can be prevented from being abutted against the ground. Even in a case where the vehicle falls, therefore, the high-pressure pipe connected to the hydraulic valve driving device and the hydraulic pump can be prevented from being damaged.

(4)

The first hydraulic path may further comprise an accumulator provided in the high-pressure pipe, and the high-pressure pipe and the accumulator may be arranged inside the outermost line connecting the outer portion of the fuel tank and the outer portion of the pump cover.

In this case, in a case where the vehicle falls, the outer portion of the fuel tank and the outer portion of the pump cover can be abutted against the ground. Consequently, both the high-pressure pipe and the accumulator can be prevented from being abutted against the ground. Even in a case where the vehicle falls, therefore, both the high-pressure pipe and the accumulator that are connected to the hydraulic valve driving device can be prevented from being damaged.

(5)

The vehicle body may further comprise a driving wheel, the engine may further comprise an oil tank, the hydraulic path may further comprise a second hydraulic path that connects the oil tank and the hydraulic pump, and the second hydraulic path may be arranged inside an outermost line connecting an outer portion of the driving wheel and the outer portion of the pump cover.

In this case, in a case where the vehicle falls, the outer portion of the driving wheel and the outer portion of the pump cover can be abutted against the ground. Consequently, the second hydraulic path can be prevented from being abutted against the ground. Even in a case where the vehicle falls, therefore, the second hydraulic path for connecting the oil tank and the hydraulic pump can be prevented from being damaged.

(6)

The hydraulic path may comprise a first hydraulic path connected to the hydraulic valve driving device, the engine may further comprise an electric generator and an electric generator cover that protects the electric generator, the first hydraulic path may comprise a low-pressure pipe for connecting a portion, in the vicinity of the electric generator, of the engine and the hydraulic valve driving device, and the low-pressure pipe may be arranged inside an outermost line connecting an outer portion of the electric generator cover and the outer portion of the fuel tank.

In this case, in a case where the vehicle falls, the outer portion of the electric generator cover in the engine and the outer portion of the fuel tank can be abutted against the ground. Consequently, the low-pressure pipe can be prevented from being abutted against the ground. Even in a case where the vehicle falls, therefore, the low-pressure pipe connected to the hydraulic valve driving device can be prevented from being damaged.

(7)

The hydraulic path may comprise a first hydraulic path connected to the hydraulic valve driving device, the engine may further comprise a cylinder head that accommodates the hydraulic valve driving device, the length of the cylinder head in the direction of the width of the vehicle body may be smaller than the length of the fuel tank in the direction of the width of the vehicle body and a length between the outermost portions of the engine in the direction of the width of the vehicle body, and the first hydraulic path may be connected to the hydraulic valve driving device within the cylinder head.

In this case, the first hydraulic path can be easily arranged inside the outermost line connecting the outer portion of the fuel tank and the outer portion of the engine.

(8)

The vehicle may further comprise a hydraulic path protection cover that protects the hydraulic path.

In this case, in a case where the vehicle falls to the ground having projections and depressions, the hydraulic path protection cover is abutted against the projections of the ground. Consequently, the hydraulic path can be reliably prevented from being abutted against the projections of the ground. Therefore, the hydraulic path can be reliably prevented from being damaged.

(9)

The hydraulic path may comprise a first hydraulic path connected to the hydraulic valve driving device, the first hydraulic path may comprise a hydraulic pipe, and an accumulator that holds hydraulic pressure in the hydraulic pipe at a predetermined value, and the hydraulic path protection cover may be formed so as to cover at least one of the hydraulic pipe and the accumulator.

In this case, even in a case where the vehicle falls to the ground having projections and depressions, at least one of the hydraulic pipe and the accumulator can be reliably prevented from being abutted against the projections of the ground.

(10)

The engine may further comprise a hydraulic pump operable to drive the hydraulic valve driving device, the hydraulic path may comprise a first hydraulic path connected to the hydraulic valve driving device and the hydraulic pump, and the hydraulic valve driving device, the hydraulic pump, and the first hydraulic path may be arranged within the engine.

In this case, the hydraulic path can be protected by the engine that is high in mechanical strength. Therefore, the hydraulic path can be easily prevented from being damaged.

(11)

According to another preferred embodiment of the present invention, a vehicle comprises an engine having a valve; a hydraulic valve driving device operable to drive the valve; a hydraulic path used for driving the hydraulic valve driving device; and a hydraulic path protection cover that protects the hydraulic path.

The vehicle is provided with the hydraulic path protection cover that protects the hydraulic path. In a case where the vehicle falls, therefore, the hydraulic path protection cover can be abutted against the ground. Consequently, the hydraulic path can be prevented from being abutted against the ground. As a result, the hydraulic path can be prevented from being damaged.

(12)

The hydraulic path may comprise a first hydraulic path connected to the hydraulic valve driving device, the hydraulic path protection cover may comprise a first hydraulic path protection cover that protects the first hydraulic path, the first hydraulic path may comprise a hydraulic pipe and an accumulator that holds hydraulic pressure in the hydraulic path at a predetermined value, and the first hydraulic path protection cover may be formed so as to cover at least one of the hydraulic pipe and the accumulator.

In this case, in a case where the vehicle falls, at least one of the first hydraulic pipe and the accumulator can be reliably prevented from being abutted against the ground.

(13)

The engine may further comprise a hydraulic pump operable to drive the hydraulic valve driving device and an oil tank, the hydraulic path may comprise a second hydraulic path that connects the hydraulic pump and the oil tank, and the hydraulic path protection cover may comprise a second hydraulic path protection cover that protects the second hydraulic path.

In this case, in a case where the vehicle falls, the second hydraulic path protection cover can be abutted against the ground. Consequently, the second hydraulic path can be prevented from being abutted against the ground. Consequently, the second hydraulic path can be prevented from being damaged.

(14)

The hydraulic path may comprise a first hydraulic path connected to the hydraulic valve driving device, the hydraulic path protection cover may comprise a first hydraulic path protection cover that protects the first hydraulic path, the engine, the hydraulic valve driving device, and the hydraulic path may constitute part of a vehicle body, and at least one of the first hydraulic path protection cover and the second hydraulic path protection cover may be arranged inside an outermost line connecting respective outermost portions of constituent elements, other than the hydraulic path, of the vehicle body.

In this case, even in a case where the vehicle falls, at least one of the first hydraulic path protection cover and the second hydraulic path protection cover can be prevented from being abutted against the ground. Consequently, the hydraulic path can be reliably prevented from being damaged. In a case where the vehicle falls to the ground having projections and depressions, the first hydraulic path protection cover or the second hydraulic path protection cover is also abutted against the projections of the ground. Therefore, the hydraulic path can be reliably prevented from being abutted against the projections of the ground. In this case, the hydraulic path can be also reliably prevented from being damaged.

(15)

The vehicle body may further comprise a fuel tank, and the first hydraulic path protection cover may be arranged inside an outermost line connecting an outer portion of the fuel tank and an outer portion of the engine.

In this case, in a case where the vehicle falls, the outer portion of the fuel tank and the outer portion of the engine can be abutted against the ground. Consequently, the first hydraulic path protection cover can be prevented from being abutted against the ground. Even in a case where the vehicle falls, therefore, the first hydraulic path connected to the hydraulic valve driving device and the hydraulic pump can be reliably prevented from being damaged.

(16)

The vehicle body may further comprise a driving wheel, and the second hydraulic path protection cover may be arranged inside an outermost line connecting an outer portion of the driving wheel and the outer portion of the engine.

In this case, in a case where the vehicle falls, the outer portion of the driving wheel and the outer portion of the engine can be abutted against the ground. Consequently, the second hydraulic path protection cover can be prevented from being abutted against the ground. Even in a case where the vehicle falls, therefore, the second hydraulic path connected to the hydraulic pump and the oil tank can be reliably prevented from being damaged.

Other features, elements, characteristics, and advantages of the present invention will become more apparent from the following description of preferred embodiments of the present invention with reference to the attached drawings.

### BRIEF DESCRIPTION OF THE DRAWINGS

FIG. 1 is a side view showing the overall configuration of a motorcycle according to a first preferred embodiment of the present invention;

FIG. 2 is a perspective view for explaining the configuration of an engine and its periphery of the motorcycle shown in FIG. 1 in detail;

FIG. 3 is a cross-sectional view taken along a line 100-100 shown in FIG. 1;

FIG. 4 is a cross-sectional view for explaining the configuration of an engine and its periphery of a motorcycle according to a second preferred embodiment of the present invention in detail;

FIG. 5 is a perspective view of the motorcycle shown in FIG. 4 as viewed from a direction indicated by an arrow P;

FIG. 6 is a perspective view for explaining the configuration of an engine and its periphery of a motorcycle according to a third preferred embodiment of the present invention in detail;

FIG. 7 is a cross-sectional view for explaining the configuration of an engine and its periphery of the motorcycle according to the third preferred embodiment of the present invention in detail; and

FIG. 8 is a cross-sectional view for explaining the configuration of an engine and its periphery of a motorcycle according to a fourth preferred embodiment of the present invention in detail.

### DETAILED DESCRIPTION OF THE PREFERRED EMBODIMENTS

Preferred embodiments of the present invention will be described while referring to the drawings. In the following preferred embodiments, a motorcycle will be described as an example of a vehicle according to the present invention.

### (1) First Preferred Embodiment

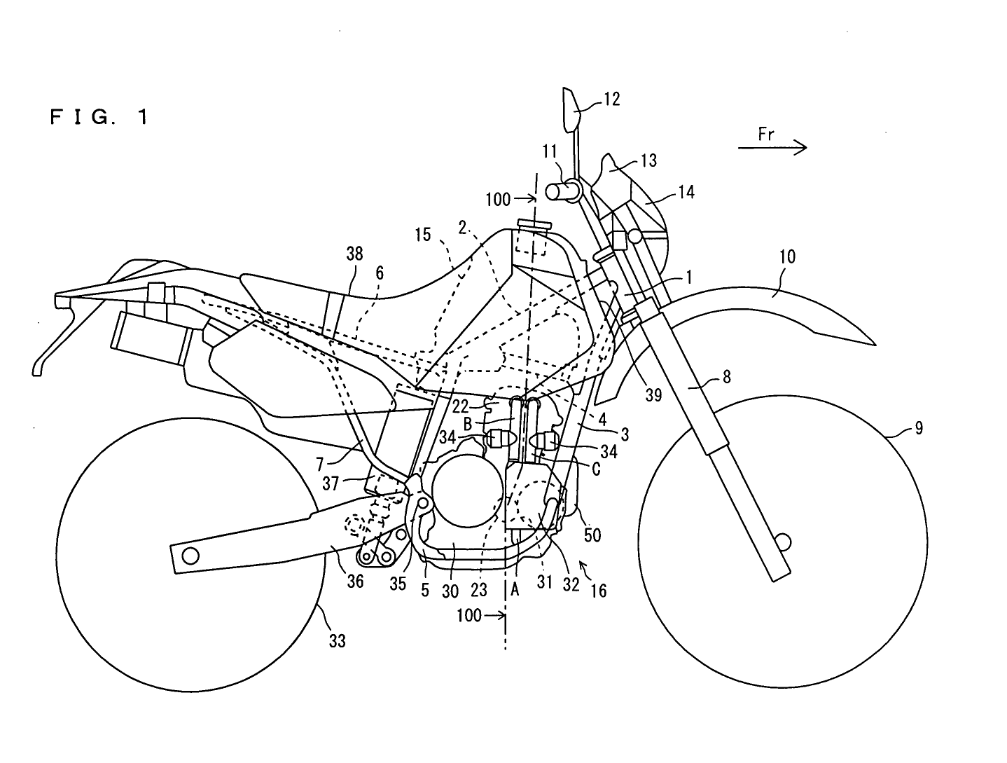

Referring now to FIGS. 1 to 3, the configuration of a motorcycle according to a first preferred embodiment of the present invention will be described in detail.

### (1-1) Overall Configuration of Motorcycle

FIG. 1 is a side view showing the overall configuration of a motorcycle according to a first preferred embodiment of the present invention. In the following description, the left and right of the motorcycle are defined toward the front Fr in the direction of travel.

In the motorcycle according to the first preferred embodiment, respective front ends of a main frame A and a down tube 3 are connected to a head pipe 1, as shown in FIG. 1. The main frame 2 is formed so as to extend obliquely downward at the rear. The down tube 3 is arranged ahead of and below the main frame 2, and extends downward at the rear. The main frame 2 and the down tube 3 are connected to each other by a back stay 4 and a pivot shaft supporting member 5.

A seat rail 6 is connected to the center of the main frame 2. A back stay 7 is connected between a rear end of the main frame 2 and the rear of the seat rail 6.

The head pipe 1, the main frame 2, the down tube 3, the back stay 4, the pivot shaft supporting member 5, the seat rail 6, and the back stay 7 constitute a vehicle body frame.

A pair of front forks 8 is arranged below the head pipe 1. A front wheel 9 is mounted so as to be rotatable on a lower part of the pair of front forks 8. A front fender 10 is arranged so as to cover an upper part of the front wheel 9.

A handle 11 is mounted so as to be rotatable on an upper end of the head pipe 1. A back mirror 12 is mounted on the inside of the handle 11. A front cowl 13 and a head light 14 are arranged ahead of the handle 11.

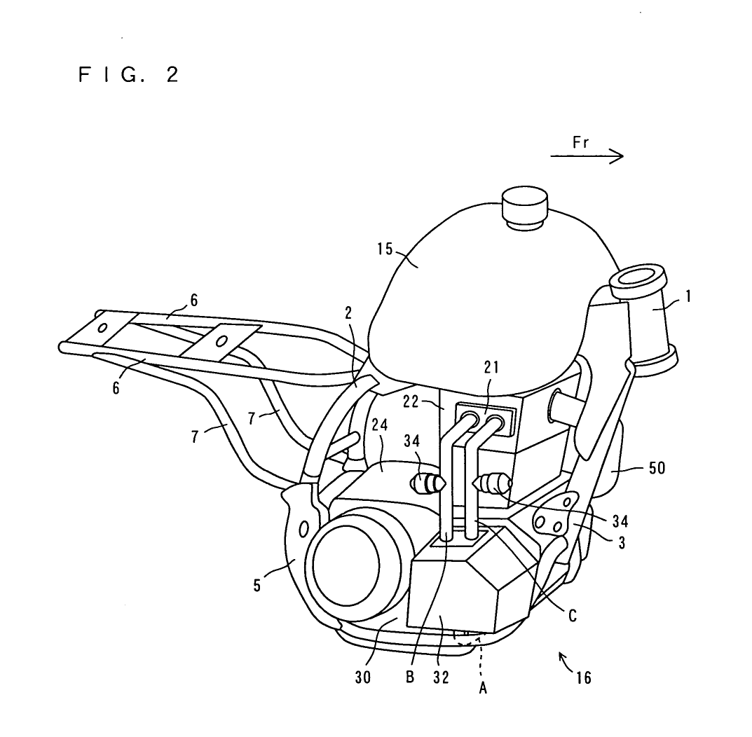

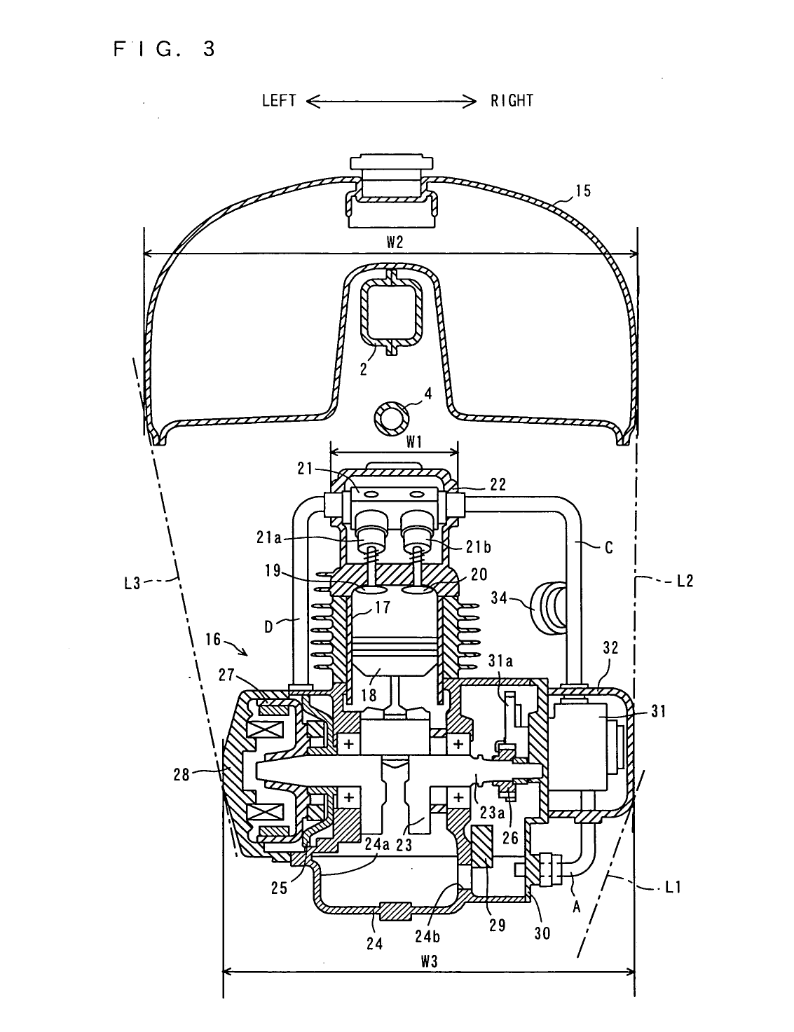

A fuel tank 15 made of a metal is mounted on the main frame 2 so as to extend over the main frame 2 (see FIGS. 2 and 3, described later). An engine 16 is arranged below the main frame 2. The detailed configuration of the engine 16 and its periphery will be described later.

The pivot shaft supporting member 5 connected to the main frame 2 is provided with a pivot shaft 35. A front end of a rear arm 36 is supported so as to be swingable up and down by the pivot shaft 35. A shock absorber 37 for damping a shock of the rear arm 36 is provided on the inside of the rear arm 36.

A rear wheel 33 is mounted so as to be rotatable at a rear end of the rear arm 36. A seat 38 is arranged on an upper part of the seat rail 6. A vehicle body cover 39 is mounted from the front to the rear of the vehicle frame so as to cover the fuel tank 15 and the seat rail 6.

### (1-2) Configuration of Engine 16 and its Periphery

FIG. 2 is a perspective view for explaining the configuration of an engine and its periphery of the motorcycle shown in FIG. 1 in detail, and FIG. 3 is a cross-sectional view taken along a line 100-100 shown in FIG. 1. Referring to FIGS. 2 and 3, the configuration of the engine and the periphery will be described in detail.

As shown in FIG. 3, the engine 16 comprises a cylinder 17, a cylinder head 22, and a crank case 24.

A piston 18 is provided so as to be movable back and forth within the cylinder 17. An intake valve 19 and an exhaust valve 20 are provided above the piston 18 in the engine 16. A hydraulic valve driving device 21 is provided above the intake valve 19 and the exhaust valve 20 within the cylinder head 22. The hydraulic valve driving device 21 has a valve actuator 21a for driving the intake valve 19 and a valve actuator 21b for driving the exhaust valve 20.

The crank case 24 accommodates a crank 23. The crank 23 has a crank shaft 23a for driving the piston 18. A starter gear 25 is arranged outside the crank case 24, and is mounted on the left of the crank shaft 23a. A transmission gear 26 is arranged outside the crank case 24, and is mounted on the right of the crank shaft 23a.

An electric generator 27 is arranged on the outside of the starter gear 25. An electric generator cover 28 is mounted on the crank case 24 so as to cover the outside the electric generator 27. A lubricating pump 29 is arranged below the transmission gear 26, and a crank case cover 30 is mounted on the crank case 24 so as to cover the outside of the lubricating pump 29.

An oil tank 24a that stores oil is formed at the bottom of the crank case 24. The oil in the oil tank 24a is supplied to a hydraulic pump 31, described later, and is also used as lubricating oil to be supplied to the crank 23 or the like by the lubricating pump 29.

An opening 24b is formed in a portion, on the side of the crank case cover 30, of the oil tank 24a, and oil is also stored in a portion that is constituted by the crank case 24 and the crank case cover 30.

A hydraulic pump 31 is mounted on an outer side surface of the crank case cover 30. A pump driven gear 31a in the hydraulic pump 31 is engaged with the transmission gear 26. A pump cover 32 made of a metal is mounted on the crank case cover 30 so as to cover the outside of the hydraulic pump 31. A hydraulic pipe A for supplying the oil from the oil tank 24a to the hydraulic pump 31 is connected between a lower part of the hydraulic pump 31 and the crank case cover 30.

Here, the hydraulic pipe A is arranged inside an outermost line L1 connecting an outer portion of the pump cover 32 and an outer portion of the front wheel 9 (see FIG. 1) or the rear wheel 33 (see FIG. 1), as shown in FIG. 3.

As shown in FIGS. 2 and 3, hydraulic pipes (high-pressure pipes) B and C are connected between an upper part of the hydraulic pump 31 and the hydraulic valve driving device 21 within the cylinder head 22. The hydraulic pipes B and C are arranged at the right of the cylinder head 22 toward the front Fr in the direction of travel. The hydraulic pipes B and C are provided so as to supply high hydraulic pressure that is raised by the hydraulic pump 31 to the hydraulic valve driving device 21.

Each of the hydraulic pipes B and C is provided with an accumulator 34 for holding the hydraulic pressure in the hydraulic pipe at a predetermined value. Here, the hydraulic pipes B and C are arranged inside an outermost line L2 connecting the outer portion of the pump cover 32 and an outer portion of the fuel tank 15, as shown in FIG. 3.

A hydraulic pipe (a return pipe (a low-pressure pipe)) D is connected between the hydraulic valve driving device 21 and a portion of the crank case 24 in the vicinity of the electric generator 27. The hydraulic pipe D is arranged at the left of the cylinder head 22 toward the front Fr in the direction of travel. The hydraulic pipe D is provided so as to return oil to the oil tank 24a within the crank case 24 when the intake valve 19 and the exhaust valve 20 are closed. The hydraulic pipe D is arranged inside an outermost line L3 connecting an outer portion of the electric generator cover 28 and the outer portion of the fuel tank 15.

The hydraulic pipes B to D and the accumulator 34 are arranged below the fuel tank 15, and are arranged above the crank case 24 in the engine 16.

The length W1 of the cylinder head 22 in the direction of the width of the motorcycle (in a right-and-left direction in FIG. 3) is formed so as to be smaller than the length W2 of the fuel tank 15 in the direction of the width of the motorcycle. The length W1 of the cylinder head 22 in the direction of the width of the motorcycle is formed so as to be smaller than the length W3 in the direction of the width from the outer portion of the electric generator cover 28 in the engine 16 to the outer portion of the pump cover 32.

Consequently, it is possible to arrange the hydraulic pipes B and C and the accumulator 34 in a space between the outermost line L2 connecting the outer portion of the pump cover 32 and the outer portion of the fuel tank 15 and the cylinder head 22. It is possible to arrange the hydraulic pipe D in a space between the outermost line L3 connecting the outer portion of the electric generator cover 28 and the outer portion of the fuel tank 15 and the cylinder head 22.

An intake pipe (not shown) and an exhaust pipe 50 (see FIG. 2) are connected to the cylinder head 22 that accommodates the hydraulic valve driving device 21.

### (1-3) Effect of First Preferred Embodiment

In the first preferred embodiment, the hydraulic pipe A is arranged inside the outermost line L1 connecting the outer portion of the pump cover 32 and the outer portion of the front wheel 9 or the rear wheel 33, as described above. The hydraulic pipes B and C and the accumulator 34 are arranged in the space between the outermost line L2 connecting the outer portion of the pump cover 32 and the outer portion of the fuel tank 15 and the cylinder head 22. Further, the hydraulic pipe D is arranged in the space between the outermost line L3 connecting the outer portion of the electric generator cover 28 and the outer portion of the fuel tank 15 and the cylinder head 22.

By such a configuration, the outer portion of the pump cover 32, the fuel tank 15, or the electric generator cover 28 is abutted against the ground when the motorcycle falls. Consequently, the hydraulic pipes A to D and the accumulator 34 can be prevented from coming into contact with the ground. As a result, the hydraulic pipes A to D and the accumulator 34 can be prevented from being damaged.

### (2) Second Preferred Embodiment

### (2-1) Configuration of Engine and its Periphery

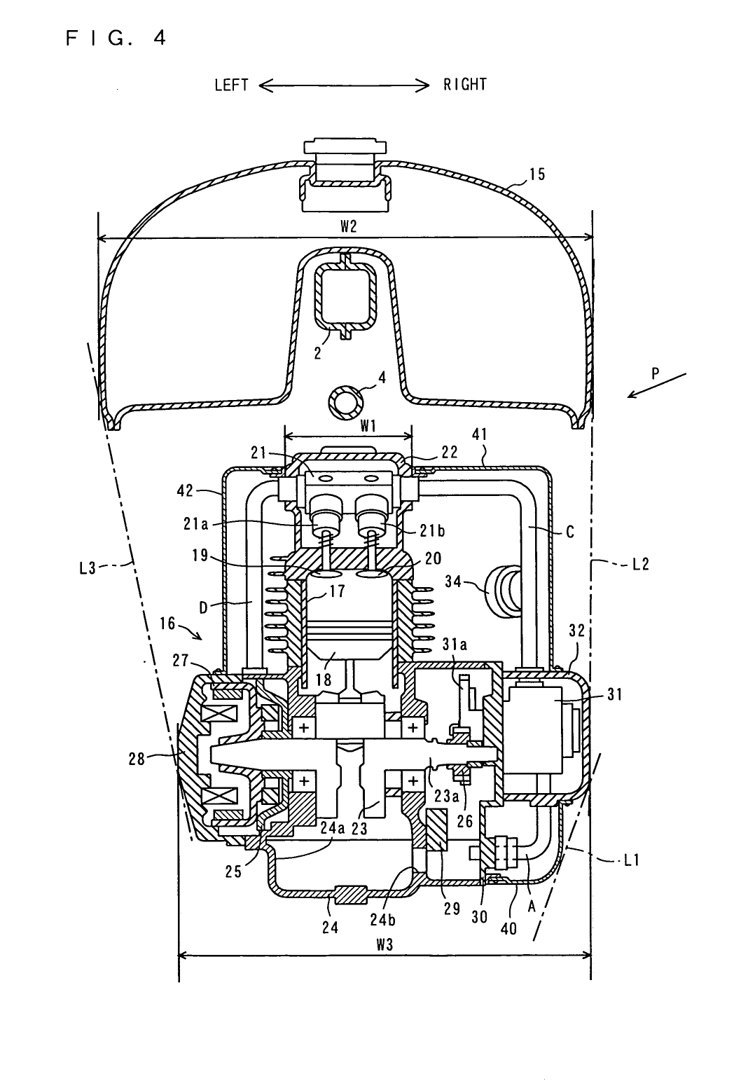

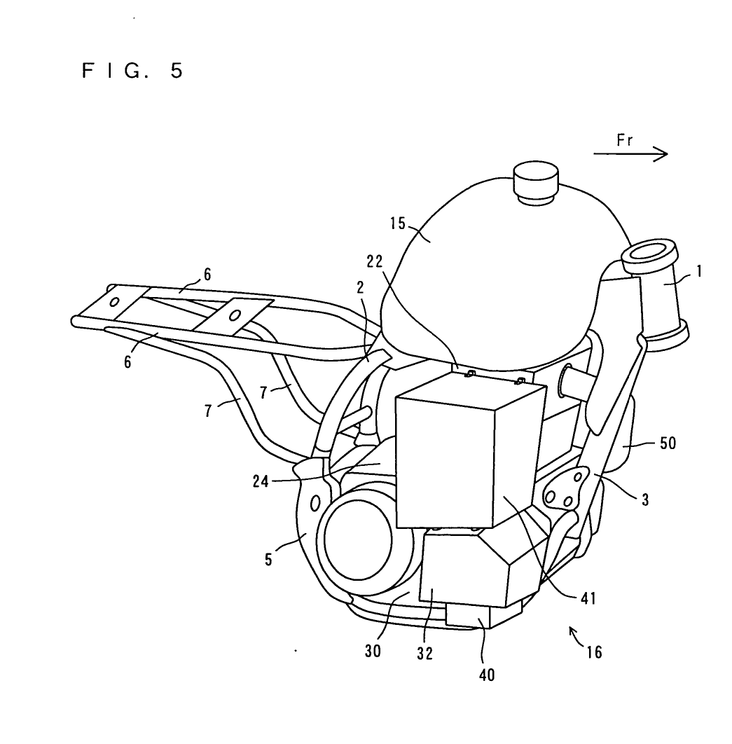

FIG. 4 is a cross-sectional view for explaining the configuration of an engine and its periphery of a motorcycle according to a second preferred embodiment of the present invention in detail, and FIG. 5 is a perspective view of the motorcycle 1 shown in FIG. 4 as viewed from a direction indicated by an arrow P.

The second preferred embodiment differs from the first preferred embodiment in that a cover for protecting a hydraulic pipe is provided.

In the motorcycle according to the second preferred embodiment, a hydraulic pipe protection cover 40 for covering a hydraulic pipe A is mounted on a crank case cover 30 and a pump cover 32, as shown in FIG. 4. The hydraulic pipe protection cover 40 is arranged inside an outermost line L1 connecting an outer portion of the pump cover 32 and an outer portion of a front wheel 9 or a rear wheel 33.

As shown in FIGS. 4 and 5, a hydraulic pipe protection cover 41 is mounted on the pump cover 32 and a cylinder head 22 so as to cover hydraulic pipes (high-pressure pipes) B and C and an accumulator 34. The hydraulic pipe protection cover 41 is arranged inside an outermost line L2 connecting the outer portion of the pump cover 32 and an outer portion of a fuel tank 15.

A hydraulic pipe protection cover 42 for covering a hydraulic pipe (a low-pressure pipe) Dismounted on an electric generator cover 28 and the cylinder head 22. The hydraulic pipe protection cover 42 is arranged inside an outermost line L3 connecting an outer portion of the electric generator cover 28 and the outer portion of the fuel tank 15.

The configuration of the other portions in the second preferred embodiment is the same as the configuration of the corresponding portions in the first preferred embodiment.

### (2-2) Effect of Second Preferred Embodiment

In the second preferred embodiment, the hydraulic pipe protection cover 40 for protecting the hydraulic pipe A, the hydraulic pipe protection cover 41 for protecting the hydraulic pipes B and C and the accumulator 34, and the hydraulic pipe protection cover 42 for protecting the hydraulic pipe D are provided, as described above.

In a case where the motorcycle falls to the ground having projections and depressions, therefore, the hydraulic pipes A to D and the accumulator 34 can be reliably prevented from being abutted against the projections of the ground. Consequently, the hydraulic pipes A to D and the accumulator 34 can be prevented from being damaged.

In the second preferred embodiment, the hydraulic pipe protection cover 40 for covering the hydraulic pipe A is arranged inside the outermost line L1 connecting the outer portion of the pump cover 32 and the outer portion of the front wheel 9 or the rear wheel 33. The hydraulic pipe protection cover 41 for covering the hydraulic pipes (high-pressure pipes) B and C and the accumulator 34 is arranged inside the outermost line L2 connecting the outer portion of the pump cover 32 and the outer portion of the fuel tank 15. Further, the hydraulic pipe protection cover 42 for covering the hydraulic pipe (low-pressure pipe) D is arranged inside the outermost line L3 connecting the outer portion of the electric generator cover 28 and the outer portion of the fuel tank 15.

Consequently, the hydraulic pipe protection covers 40 to 42 can be reliably prevented from being abutted against the ground. Consequently, the hydraulic pipes A to D and the accumulator 34 can be reliably prevented from being damaged.

Even in a case where the motorcycle falls to the ground having projections and depressions, the hydraulic pipe protection covers 40 to 42 are abutted against the projections of the ground. Therefore, the hydraulic pipes A to D and the accumulator 34 can be reliably prevented from coming into contact with the projections of the ground. In this case, the hydraulic pipes A to D and the accumulator 34 can be also reliably prevented from being damaged.

The other effect of the second preferred embodiment is the same as the effect of the first preferred embodiment.

### (3) Third Preferred Embodiment

### (3-1) Configuration of Engine and its Periphery

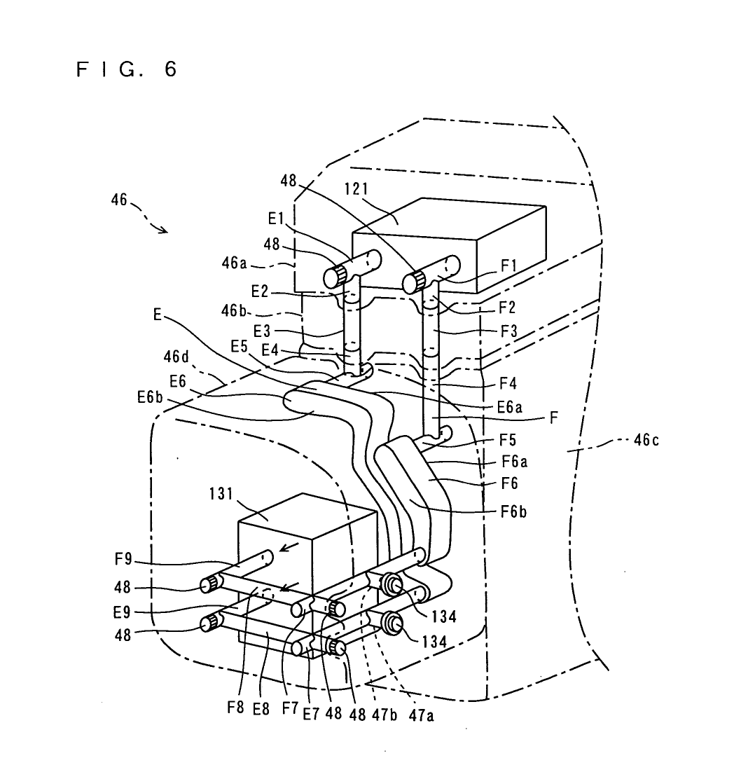

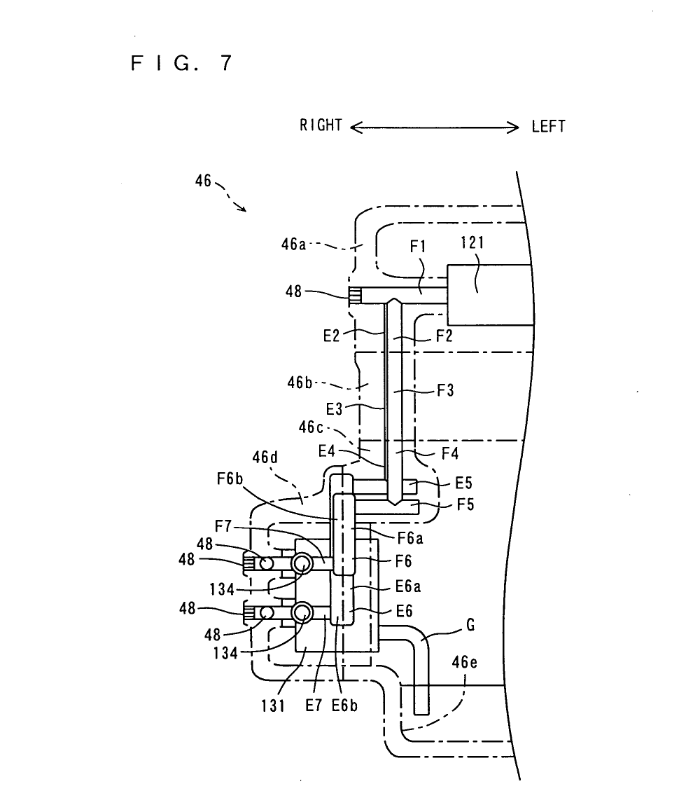

FIG. 6 is a perspective view for explaining the configuration of an engine and its periphery of a motorcycle according to a third preferred embodiment of the present invention in detail, and FIG. 7 is a cross-sectional view for explaining the engine and its periphery of the motorcycle according to the third preferred embodiment of the present invention in detail.

The third preferred embodiment differs from the first and second preferred embodiments in that a hydraulic pump and a hydraulic path connecting the hydraulic pump and a hydraulic valve driving device are arranged within the engine.

In the motorcycle according to the third preferred embodiment, an engine 46 comprises a cylinder head 46a, a cylinder body 46b, a crank case 46c, and a pump cover 46d, as shown in FIGS. 6 and 7. The cylinder head 46a, the cylinder body 46b, the crank case 46c, and the pump cover 46d are integrally formed by being joined to one another after casting.

Hydraulic paths E and F are formed, as shown in FIG. 7, within the engine 46. The hydraulic path E is constituted by hydraulic paths E1 to E9, and the hydraulic path F is constituted by hydraulic paths F1 to F9.

The hydraulic paths E1 to E9 and the hydraulic paths F1 to F9 are formed by connecting paths respectively formed in the cylinder head 46a, the cylinder body 46b, the crank case 46c, and the pump cover 46d.

Specifically, the hydraulic paths E1 to E5 and E7 to E9 and the hydraulic paths F1 to F5 and F7 to F9 are formed in a hole shape by a drill. Portions, corresponding to the hydraulic paths E6 and F6, of the crank case 46c are respectively formed with recesses E6a and F6a at the time of casting. Portions, corresponding to the hydraulic paths E6 and F6, of the pump cover 46d are respectively formed with recesses E6b and F6b at the time of casting.

The crank case 46c and the pump cover 46d are joined to each other such that the recesses E6a and E6b form the hydraulic path E6 and the recesses F6a and F6b form the hydraulic path F6. The pump cover 46d is formed with through holes 47a and 47b respectively communicating with the hydraulic paths E7 and F7 by a drill. Respective outer ends of the hydraulic paths E1, E8, E9, F1, F8, and F9 are sealed with a plug member 48.

A hydraulic valve driving device 121 is arranged within the cylinder head 46a. A hydraulic pump 131 is arranged in an area from the crank case 46c to the pump cover 46d. The hydraulic valve driving device 121 and the hydraulic pump 131 are connected to each other by the hydraulic paths E and F.

A hydraulic pipe G composed of a normal piping member for supplying to the hydraulic pump 131 oil in a hydraulic tank 46e formed in the crank case 46c is mounted, as shown in FIG. 7, on a lower part of the hydraulic pump 131. The hydraulic pipe G is also arranged within the crank case 46c. An accumulator 134 for holding hydraulic pressure in the hydraulic paths E and F at a predetermined value through the through holes 47a and 47b is mounted on the outside of the pump cover 46d.

The configuration of the other portions in the third preferred embodiment is the same as the configuration of the corresponding portions in the first preferred embodiment.

### (3-2) Effect of Third Preferred Embodiment

In the third preferred embodiment, the hydraulic valve driving device 121, the hydraulic pump 131, the hydraulic paths E and F, and the hydraulic pipe G are arranged within the engine 46, as described above. Thus, the hydraulic paths E and F and the hydraulic pipe G can be protected by the engine 46 that is high in mechanical strength. Consequently, the hydraulic paths E and F and the hydraulic pipe G can be prevented from being damaged.

The other effect in the third preferred embodiment is the same as the effect in the first preferred embodiment.

### (4) Fourth Preferred Embodiment

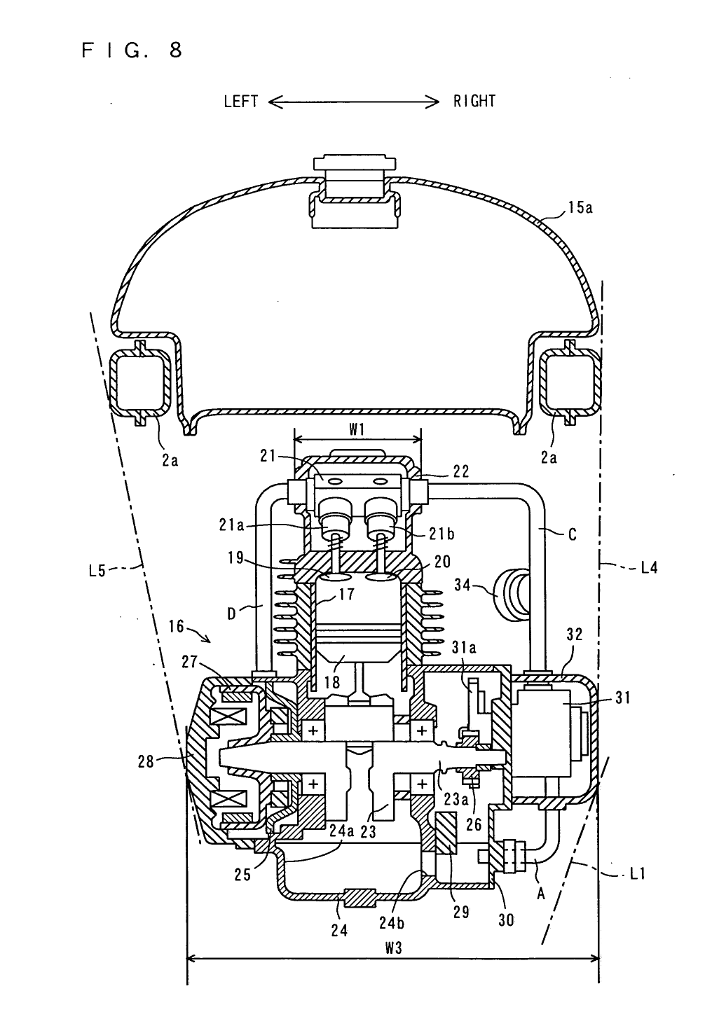

FIG. 8 is a cross-sectional view for explaining the configuration of an engine and its periphery of a motorcycle according to a fourth preferred embodiment of the present invention in detail.

Although in the above-mentioned preferred embodiment, the fuel tank 15 is mounted so as to extend over the main frame 2 so that the lines respectively connecting the outer portion of the fuel tank 15 and the outer portions of the pump cover 32 and the electric generator cover 28 are the outermost lines L2 and L3, the present invention is not limited to the same. As in the fourth preferred embodiment of the present invention shown in FIG. 8, a main frame 2a divided in a right-and-left direction in the motorcycle with a fuel tank 15a sandwiched therebetween may be used so that lines respectively connecting an outer portion of the main frame 2a and outer portions of a pump cover 32 and an electric generator cover 28 are outermost lines L4 and L5.

### (5) Another Preferred Embodiment

Although in the above-mentioned second preferred embodiment, the hydraulic pipes A, B and C, and D provided with the hydraulic pipe protection covers 40 to 42 are respectively arranged inside the outermost lines L1 to L3, the present invention is not limited to the same. The hydraulic pipes A, B and C, and D provided with the hydraulic pipe protection covers 40 to 42 may be respectively arranged outside the outermost lines L1 to L3.

Although in the above-mentioned third preferred embodiment, each of the hydraulic paths E and F is formed by connecting the path portions formed within the engine 46, the present invention is not limited to the same. The paths for connecting the hydraulic valve driving device 121 and the hydraulic pump 131 may be provided separately from the engine 46 within the engine 46. In this case, the accumulator 134 may be arranged within the engine 46.

Furthermore, although in the above-mentioned preferred embodiments, the motorcycle is illustrated as an example of the vehicle including the hydraulic valve driving device for driving the engine valve, the present invention is not limited to the same. The present invention is also applicable to other vehicles such as a tricycle and an ATV (All Terrain Vehicle), provided that the vehicles includes the hydraulic valve driving device for driving the engine valve. The hydraulic valve driving device for driving the engine valve may be applied to a mechanical apparatus other than the vehicle.

It should be considered that the above-mentioned preferred embodiments are not restrictive but illustrative in all respects. While preferred embodiments of the present invention have been described above, it is to be understood that variations and modifications will be apparent to those skilled in the art without departing the scope and spirit of the present invention. The scope of the present invention, therefore, is to be determined solely by the following claims.

### (6) Correspondence between Constituent element in Claims and Constituent Element in Preferred Embodiments

In the following paragraph, non-limiting examples of correspondences between various elements recited in the claims below and those described above with respect to various preferred embodiments of the present invention are explained.

In the preferred embodiments described above, the front wheel 9 or the rear wheel 33 corresponds to a driving wheel, the engine 16 or 46 corresponds to an engine, the intake valve 19 or the exhaust valve 20 corresponds to an engine valve, and the hydraulic valve driving device 21 corresponds to a hydraulic valve driving device. Further, the hydraulic pipe A corresponds to a hydraulic path or a second hydraulic path, the hydraulic pipes B, C, D, E, F and G, and the accumulator 34 correspond to a hydraulic path, the hydraulic pipe protection cover 40 corresponds to a second hydraulic path protection cover, and the hydraulic pipe protection covers 41 and 42 correspond to a first hydraulic path protection cover.

What is claimed is:

1. A vehicle comprising:
an engine having a valve;
a hydraulic valve driving device operable to drive the valve; and
a hydraulic path arranged to supply a driving force to the hydraulic valve driving device,
the engine, the hydraulic valve driving device, and the hydraulic path constituting part of a vehicle body, and
the hydraulic path being arranged inside an outermost line connecting respective outermost portions of constituent elements, other than the hydraulic path, of the vehicle body.

2. The vehicle according to claim 1, wherein
the vehicle body further comprises a vehicle body frame that holds the engine, and a fuel tank mounted on the vehicle body frame, and
the hydraulic path is arranged inside an outermost line connecting at least two of an outer portion of the engine, an outer portion of the fuel tank, and an outer portion of the vehicle body frame.

3. The vehicle according to claim 2, wherein
the hydraulic path comprises a first hydraulic path connected to the hydraulic valve driving device,
the engine further comprises a hydraulic pump operable to drive the hydraulic valve driving device and a pump cover that protects the hydraulic pump,
the first hydraulic path comprises a high-pressure pipe that connects the hydraulic pump and the hydraulic valve driving device, and
the high-pressure pipe is arranged inside an outermost line connecting the outer portion of the fuel tank and an outer portion of the pump cover.

4. The vehicle according to claim 3, wherein
the first hydraulic path further comprises an accumulator provided in the high-pressure pipe, and
the high-pressure pipe and the accumulator are arranged inside the outermost line connecting the outer portion of the fuel tank and the outer portion of the pump cover.

5. The vehicle according to claim 3, wherein
the vehicle body further comprises a driving wheel,
the engine further comprises an oil tank,
the hydraulic path further comprises a second hydraulic path that connects the oil tank and the hydraulic pump, and
the second hydraulic path is arranged inside an outermost line connecting an outer portion of the driving wheel and the outer portion of the pump cover.

6. The vehicle according to claim 2, wherein
the hydraulic path comprises a first hydraulic path connected to the hydraulic valve driving device,
the engine further comprises an electric generator and an electric generator cover for protecting the electric generator,
the first hydraulic path comprises a low-pressure pipe that connects a portion, in the vicinity of the electric generator, of the engine and the hydraulic valve driving device, and
the low-pressure pipe is arranged inside an outermost line connecting an outer portion of the electric generator cover and the outer portion of the fuel tank.

7. The vehicle according to claim 2, wherein
the hydraulic path comprises a first hydraulic path connected to the hydraulic valve driving device,
the engine further comprises a cylinder head that accommodates the hydraulic valve driving device,
the length of the cylinder head in the direction of the width of the vehicle body is smaller than the length of the fuel tank in the direction of the width of the vehicle body and a length between the outermost portions of the engine in the direction of the width of the vehicle body, and
the first hydraulic path is connected to the hydraulic valve driving device within the cylinder head.

8. The vehicle according to claim 1, further comprising a hydraulic path protection cover that protects the hydraulic path.

9. The vehicle according to claim 8, wherein
the hydraulic path comprises a first hydraulic path connected to the hydraulic valve driving device,
the first hydraulic path comprises a hydraulic pipe, and an accumulator that holds hydraulic pressure in the hydraulic pipe at a predetermined value, and
the hydraulic path protection cover is formed so as to cover at least one of the hydraulic pipe and the accumulator.

10. The vehicle according to claim 1, wherein
the engine further comprises a hydraulic pump operable to drive the hydraulic valve driving device,
the hydraulic path comprises a first hydraulic path connected to the hydraulic valve driving device and the hydraulic pump, and
the hydraulic valve driving device, the hydraulic pump, and the first hydraulic path are arranged within the engine.

11. A vehicle comprising:
an engine having a valve;
a hydraulic valve driving device operable to drive the valve;
a hydraulic path used for driving the hydraulic valve driving device; and
a hydraulic path protection cover that protects the hydraulic path.

12. The vehicle according to claim 11, wherein
the hydraulic path comprises a first hydraulic path connected to the hydraulic valve driving device,
the hydraulic path protection cover comprises a first hydraulic path protection cover that protects the first hydraulic path,
the first hydraulic path comprises a hydraulic pipe and an accumulator that holds hydraulic pressure in the hydraulic path at a predetermined value, and
the first hydraulic path protection cover is formed so as to cover at least one of the hydraulic pipe and the accumulator.

13. The vehicle according to claim 11, wherein
the engine further comprises a hydraulic pump operable to drive the hydraulic valve driving device and an oil tank,
the hydraulic path comprises a second hydraulic path that connects the hydraulic pump and the oil tank, and
the hydraulic path protection cover comprises a second hydraulic path protection cover that protects the second hydraulic path.

14. The vehicle according to claim 13, wherein
the hydraulic path comprises a first hydraulic path connected to the hydraulic valve driving device,
the hydraulic path protection cover comprises a first hydraulic path protection cover that protects the first hydraulic path,
the engine, the hydraulic valve driving device, and the hydraulic path constitute part of a vehicle body, and
at least one of the first hydraulic path protection cover and the second hydraulic path protection cover is arranged inside an outermost line connecting respective outermost portions of constituent elements, other than the hydraulic path, of the vehicle body.

15. The vehicle according to claim 14, wherein
the vehicle body further comprises a fuel tank, and
the first hydraulic path protection cover is arranged inside an outermost line connecting an outer portion of the fuel tank and an outer portion of the engine.

16. The vehicle according to claim 14, wherein
the vehicle body further comprises a driving wheel, and
the second hydraulic path protection cover is arranged inside an outermost line connecting an outer portion of the driving wheel and the outer portion of the engine.
